(19) United States
(12) Patent Application Publication
(10) Pub. No.: US 2022/0326189 A1
(43) Pub. Date: Oct. 13, 2022

(54) ULTRASOUND SCANNER APPARATUS

(71) Applicant: Quest Integrity Group, LLC, Houston, TX (US)

(72) Inventor: Christopher Thomas JONES, Bogangar (AU)

(21) Appl. No.: 17/762,916

(22) PCT Filed: Sep. 22, 2020
(86) PCT No.: PCT/US2020/051985

§ 371 Date: Mar. 23, 2022

Related U.S. Application Data
(60) Provisional application No. 62/904,920, filed on Sep. 24, 2019.

(51) Int. Cl. G01N 29/22; G01N 29/265

(52) U.S. Cl. CPC G01N 29/225; G01N 29/265; G01N 2291/2634

(57) ABSTRACT

An ultrasonic testing inspection scanner is provided for scanning a pipe. The inspection scanner may comprise a frame assembly having a first frame section and a second frame section coupled together, wherein the frame assembly is configured to be positioned between an open position to allow the frame assembly to be placed on the pipe and a closed position where the frame assembly is mounted on the pipe with the frame assembly extending around a circumference of the pipe. Additionally, the inspection scanner may comprise a first probe carrier and a second probe carrier, each having an elongated shape with first and second attachment ends as well as first and second extended ends, respectively. A first probe apparatus may be coupled to the first probe carrier and a second probe apparatus may be coupled to the second probe carrier in an orientation which facilitates testing of the pipe in obstructed or difficult to reach areas.

### CROSS-REFERENCE TO RELATED APPLICATION

The present document is based on and claims priority to U.S. Provisional Application Ser. No. 62/904,920, filed Sep. 24, 2019, which is incorporated herein by reference in its entirety.

### FIELD OF DISCLOSURE

In general, the disclosure describes an ultrasound inspection scanner and methods for performing ultrasound inspections. The ultrasound inspection scanner is specifically configured to perform ultrasound inspections of supported pipes at risk of touch point corrosion.

### BACKGROUND OF DISCLOSURE

Touch point corrosion of a pipe, sometimes referred to as a tubular, may occur at a wall section of a pipe where the pipe is supported by a pipe support. Touch point corrosion may cause an operational risk for the pipe. Nondestructive testing using an ultrasound inspection scanner may be used to determine whether and to the extent that touch point corrosion has reduced the wall thickness of the pipe. An ultrasound inspection scanner may be mounted on the outer diameter of a pipe for performing ultrasound testing of the pipe at the wall section subject to touch point corrosion. An ultrasound inspection scanner includes at least one probe apparatus for projecting and receiving acoustic waves to measure wall thickness of a pipe that may have been impacted by touch point corrosion. The probe apparatus is placed adjacent to the pipe in the proximate location of the wall section being scanned. However, positioning the ultrasound inspection scanner and the probe apparatus adjacent to the pipe can be difficult due to the shape and positioning of the pipe support or other interfering structures. There may be limited space for mounting the ultrasound inspection scanner and for positioning the probe apparatus.

What is needed is an improved ultrasound inspection scanner that allows the ultrasound inspection scanner and the probe apparatus to be effectively positioned and moved so as to facilitate touch point corrosion inspections.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

An embodiment of the present disclosure provides an ultrasonic testing (UT) inspection scanner for scanning a pipe. The UT inspection scanner may comprise a frame assembly having a first frame section and a second frame section coupled together, e.g. hinged together, wherein the frame assembly is configured to be positioned between an open position to allow the frame assembly to be placed on the pipe and a closed position where the frame assembly is mounted on the pipe with the frame assembly extending around a circumference of the pipe. Additionally, the UT inspection scanner may comprise a first probe carrier and a second probe carrier, each having an elongated shape with first and second attachment ends as well as first and second extended ends, respectively. A first probe apparatus may be coupled to the first probe carrier, wherein the first probe apparatus is attached at the first extended end of the first probe carrier. A second probe apparatus may be coupled to the second probe carrier, wherein the second probe apparatus is attached at the second extended end of the second probe carrier. A wheel may be attached to the frame assembly and configured to allow the frame assembly to move longitudinally on the pipe when the frame assembly is in the closed position.

Another embodiment of the present disclosure further provides the UT inspection scanner described above wherein the first probe carrier and the second probe carrier are attached to a bottom section of the frame assembly and extend longitudinally from the frame assembly.

### BRIEF DESCRIPTION OF THE FIGURES

Certain embodiments of the disclosure will hereafter be described with reference to the accompanying drawings, wherein like reference numerals denote like elements. It is emphasized that, in accordance with standard practice in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein, and:

FIG. 1 is a front perspective view of an ultrasound inspection scanner in accordance with embodiments of the present disclosure;

FIG. 2 is a front view of the ultrasound inspection scanner in accordance with embodiments of the present disclosure;

FIG. 3 is a side view of the ultrasound inspection scanner in accordance with embodiments of the present disclosure; and

FIG. 4 is a schematic view showing a pair of probe apparatuses and a depiction of ultrasound waves used in an ultrasound inspection of a pipe in accordance with embodiments of the present disclosure.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements.

According to an embodiment, an ultrasonic testing inspection scanner is provided for scanning a pipe. The inspection scanner may comprise a frame assembly having a first frame section and a second frame section coupled together, e.g. hinged together, wherein the frame assembly is configured to be positioned between an open position to allow the frame assembly to be placed on the pipe and a closed position where the frame assembly is mounted on the pipe with the frame assembly extending around a circumference of the pipe. Additionally, the inspection scanner may comprise a first probe carrier and a second probe carrier, each having an elongated shape with first and second attachment ends as well as first and second extended ends, respectively. A first probe apparatus may be coupled to the first probe carrier and a second probe apparatus may be coupled to the second probe carrier in an orientation which facilitates testing of the pipe in obstructed or difficult to reach areas, e.g. proximate a pipe support.

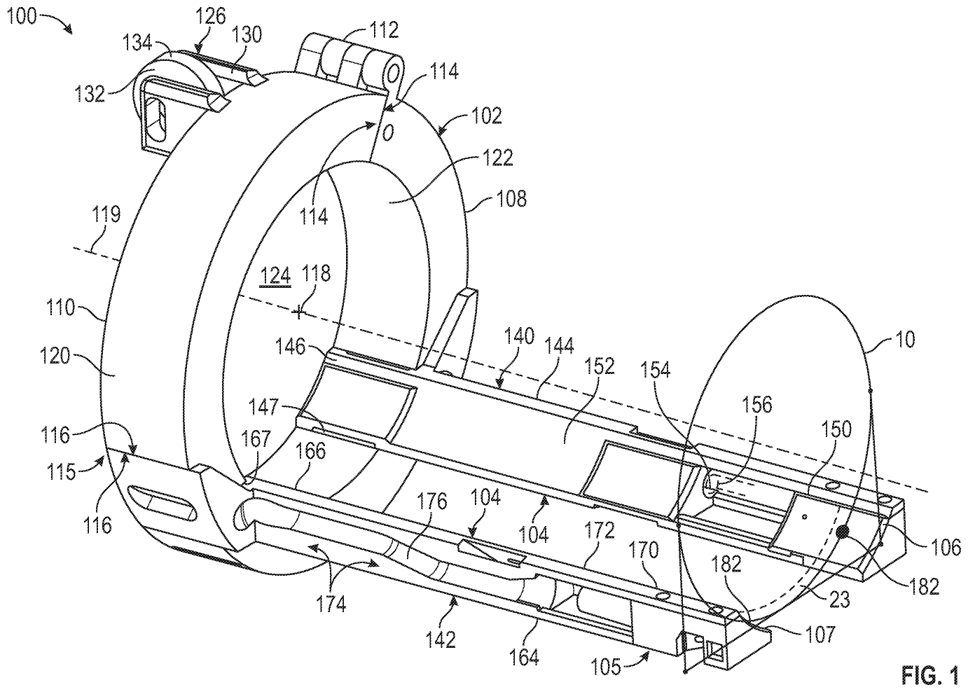

Referring generally to FIGS. 1-3, an embodiment of an ultrasound inspection scanner, referenced generally as 100, of the present disclosure is shown. The ultrasound inspection scanner 100 also may be referred to as an ultrasonic testing (UT) inspection scanner 100. The UT inspection scanner 100 is configured to perform an ultrasound inspection of a wall of a pipe 10. UT inspection scanner 100 includes a frame assembly 102 and a probe carrier assembly 104 attached to the frame assembly 102. Probe carrier assembly 104 includes a first probe apparatus 106 and a second probe apparatus 107 spaced apart from each other. Each probe apparatus 106, 107 sends ultrasound waves to a wall section 23 of the pipe 10 and receives ultrasound waves reflected from the pipe 10 during the ultrasound inspection. A portion of the pipe 10 is schematically shown in FIGS. 1-3 as positioned through an extended end section 105 of the probe carrier assembly 104. The pipe 10 extends through the frame assembly 102 during inspection by the UT inspection scanner 100.

Frame assembly 102 is formed by a first frame section 108 and a second frame section 110. In the embodiment shown in FIGS. 1-3, the first frame section 108 is a lower frame section and the second frame section 110 is an upper frame section. Frame sections 108, 110 are releasably coupled together. For example, frame sections 108, 110 may be coupled together at a hinge section 112 which places frame section ends 114 adjacent each other upon closure of frame assembly 102. Frame assembly 102 has an access section 115 spaced from the hinge section 112 where access ends 116 of the frame sections 108, 110 are positioned adjacent one another when the frame assembly 102 is in a closed position, as shown in FIGS. 1-3. Frame sections 108, 110 pivot with respect to one another via hinge 112, e.g. a frame hinge, to allow ends 116 of the frame sections 108, 110 to separate from one another at the access section 115 so as to move the frame assembly 102 from the closed position to an open position. When in the open position, access section 115 forms a sufficiently large access opening so the frame assembly 102 may be positioned about the pipe 10 (or pipe 10 can be inserted into frame assembly 102 via open access section 115).

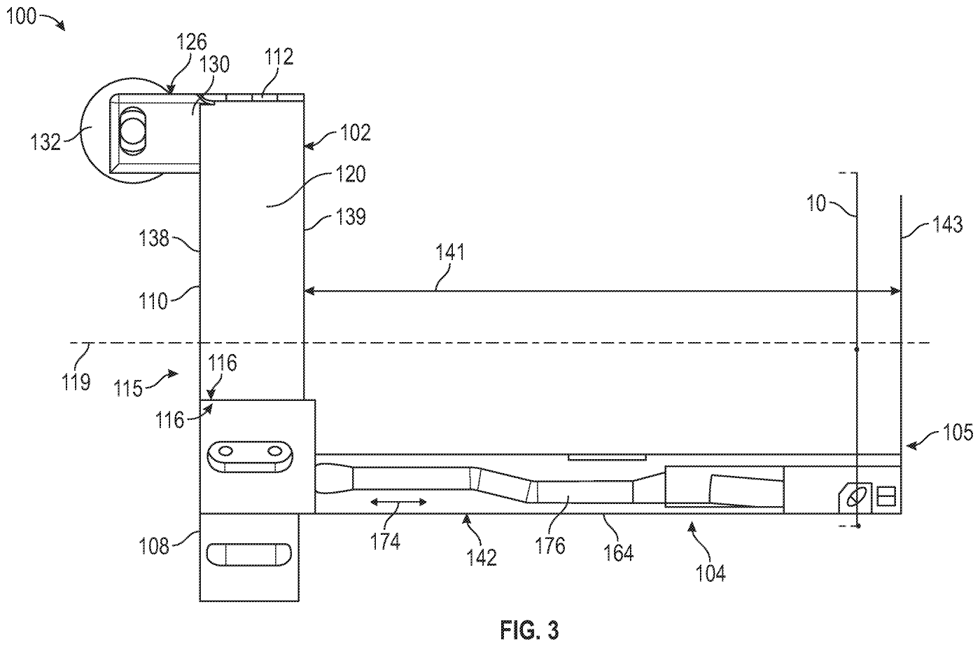

Frame sections 108, 110 may each have a semi-circular shape to form the frame assembly 102. In a closed position, the illustrated frame assembly 102 has a cylindrical shape which establishes a frame center 118 and a frame longitudinal axis 119 extending longitudinally through the frame assembly 102 (see FIG. 3). Frame assembly 102 has a frame outer surface 120 and a frame inner surface 122. Frame inner surface 122 defines an internal diameter area 124 of the frame assembly 102.

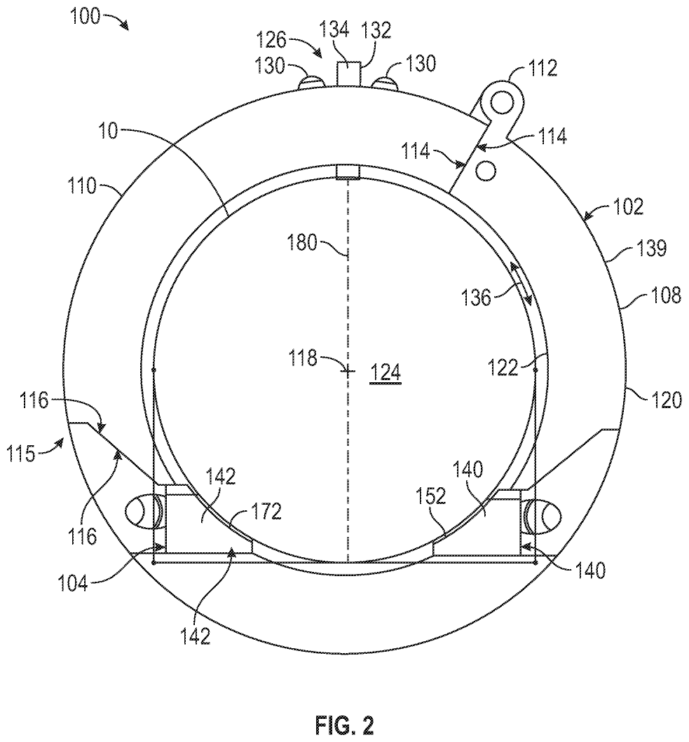

A wheel assembly 126 may be secured at a top section of the frame assembly 102. Wheel assembly 126 includes a wheel support 130 for supporting a wheel 132 on the frame assembly 102. Wheel support 130 positions wheel 132 to extend from a first frame side 138 of the frame assembly 102, e.g. from the first side 138 of second frame section 110 (see FIG. 3). In the illustrated example, wheel 132 has a wheel outer surface 134 and is configured to have an outer diameter such that the wheel 126 extends above the frame outer surface 120 and extends below the frame inner surface 122. Wheel 132 is configured to support the frame assembly 102 on the pipe 10 with the wheel outer surface 134 engaging the pipe 10 when the frame assembly 102 is mounted on the pipe 10. When the frame assembly 102 is mounted on the pipe 10, the frame inner surface 122 is spaced from the pipe 10 to form an annular space 136 between the frame assembly 102 and the pipe 10 (see FIG. 2).

Probe carrier assembly 104 may be formed by a first probe carrier 140 and a second probe carrier 142 spaced apart from one another and longitudinally extending from the frame assembly 102. Probe carriers 140, 142 each have an elongated shape and are fixed to the frame assembly 102 at one end. First probe carrier 140 may include a first extended housing 144 having a first frame connector 146 and a first probe support 150 (see FIG. 1). An extended end of the first probe carrier 140 is formed by the first probe support 150. First frame connector 146 forms a first attachment end of the first probe carrier 140 and is attached to a bottom portion of the frame assembly 102. In the embodiment shown in FIGS. 1-3, the first frame connector 146 is positioned in a frame slot 147 extending into the frame inner surface 122. First probe support 150 is spaced at an extended location from the frame assembly 102 and is thus separated longitudinally from the frame assembly 102 a desired distance.

First extended housing 144 may have an elongated wedge shape configured so that the first probe carrier 140 may be positioned along the longitudinal length of a pipe 10 and adjacent to and below an outside surface of a pipe. First extended housing 144 includes a first housing outer surface 152 that extends from the internal diameter of the frame assembly 102 to the first probe support 150. First housing outer surface 152 may have a concave shape and may be disposed outwardly and above the internal diameter of the frame assembly 102 (see FIG. 2). First housing outer surface 152 may extend outwardly from the frame assembly 102 and parallel to the longitudinal axis 119. A first housing channel 154 is formed in the first extended housing 144 and is configured to house a first conduit 156 for carrying signal lines and power lines from the first probe apparatus 106 in the first probe support 150 of the first probe carrier 140 to the frame assembly 102.

First probe support 150 may be configured to allow the first probe apparatus 106 to be positioned longitudinally outwardly from the frame assembly 102. In some embodiments, the first apparatus probe 106 may be located at multiple extended positions with respect to the frame assembly 102 via adjustable extension of housing 144; substitution of different length housings 144; or adjustment of each probe apparatus 106, 107 along the corresponding probe carriers 140, 142.

Second probe carrier 142 of probe carrier assembly 104 includes a second extended housing 164 having a second frame connector 166 and a second probe support 170 (see FIG. 1). An extended end of the second probe carrier 142 is formed by the second probe support 170. Second frame connector 166 forms a second attachment end of the second probe carrier 142 and is attached to a bottom portion of the frame assembly 102. In the embodiment shown in FIGS. 1-3, the second frame connector 166 is positioned in a frame slot 167 extending into the frame inner surface 122. Second probe support 170 is positioned longitudinally from the frame assembly 102 at a desired distance from frame assembly 102.

Second extended housing 164 may have an elongated wedge shape configured so that the second probe carrier 142 may be positioned along the longitudinal length of a pipe and adjacent to and below an outside surface of a pipe. Second extended housing 164 includes a second housing outer surface 172 that extends from the internal diameter of the frame assembly 102 to the second probe support 170. Second housing outer surface 172 may have a concave shape and may be disposed above the internal diameter of the frame assembly 102 from the second frame connector 166 to the second probe support 170 in the elevated position (see FIG. 2). A second housing channel 174 is formed in the second extended housing 164 and is configured to house a second conduit 176 for carrying signal lines and power lines from the second probe apparatus 107 in the second probe support 170 of the second probe carrier 142 to the frame assembly 102.

Probe carriers 140, 142 each extend longitudinally from the frame assembly 102. First probe carrier 140 has a first longitudinal axis and second probe carrier 142 has a second longitudinal axis. The first longitudinal axis and the second longitudinal axis extending through corresponding centers of their respective probe carriers 140, 142. In the embodiment illustrated, probe carriers 140, 142 are configured so that the first longitudinal axis and the second longitudinal axis are parallel to one another and parallel to the frame longitudinal axis 119.

Probe carriers 140, 142 may be attached to and circumferentially spaced apart on a bottom half of the frame assembly 102, as shown in FIG. 1 and FIG. 2. Frame connectors 146, 166 of the probe carriers 140, 142 are spaced apart from each other and attached on the frame assembly 102 so that each has an equal angular distance from a vertical axis 180 extending through center 118 and a bottom of the frame assembly 102 (see FIG. 2). In some embodiments, the probe carriers 140, 142 are each positioned so that the first longitudinal axis of the first probe carrier 140 and the second longitudinal axis of the second probe carrier 142 have an angular separation.

Probe carriers 140, 142 are configured to extend from the frame assembly 102 to allow the probe apparatuses 106, 107 to be positioned adjacent to a pipe wall overlying a pipe support or otherwise obstructed. The separation of the frame assembly 102 from the supported probe apparatuses 106, 107 allows the frame assembly 102 to be more easily mounted on pipe 10 at a desired distance away from obstructions that may exist near the pipe support. The probe apparatuses 106, 107 may thus be positioned adjacent to a pipe wall section subject to corrosion, e.g. a wall section of the pipe engaging the pipe support, while the distant frame assembly 102 secures the UT inspection scanner 100 to the pipe 10. In some embodiments, the extended distance between the second frame side 139 of the frame assembly 102 and each of the probe apparatuses 106, 107 is greater than the internal diameter of the frame assembly 102. Referring generally to FIG. 3, the distance from second frame side 139 to the extended ends of the probe carriers 140, 142 is illustrated by line 141 (which extends from second frame side 139 to a vertical axis 143 rising vertically from the extended ends of the probe carriers 140, 142). According to the illustrated example, the distance 141 is greater than the internal diameter of frame assembly 102.

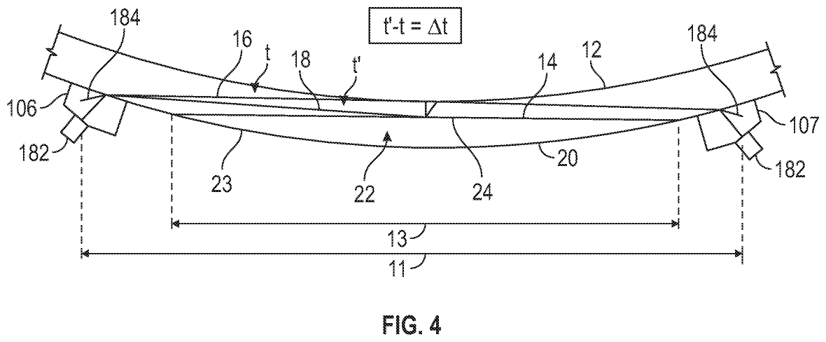

Probe apparatuses 106, 107 each may include a probe 182 for projecting ultrasound to and for receiving ultrasound from pipe 10 (see FIG. 1). In some embodiments, the probe 182 may be formed by a probe array. Probe apparatuses 106, 107 may include the probe 182 with an adjustable mirror 184. The adjustable mirror 184 is configured to reflect ultrasound projected from and reflected to the corresponding probe 182 during scanning of pipe 10 (see FIGS. 3 and 4).

Each probe 182 may have a probe face through which the projected ultrasound and reflected ultrasound pass. According to some embodiments, ultrasound waves are projected from the probe 182 toward the adjustable mirror 184 and the angle of the projected ultrasound waves may be adjusted by a mirror adjustment assembly including a motor. The angle of the ultrasound waves projected from the probe 182 may be changed be moving the adjustable mirror 184 using the mirror adjustment assembly. Likewise, at least a portion of the projected ultrasound waves is reflected by the pipe and directed to the adjustable mirror which changes the angle of reflection and directs these reflected ultrasound waves to the probe 182. The combination of the probe 182 and the adjustable mirror 184 may be used to measure the thickness and width of a wall section of a pipe. For example, the probe 182 and the adjustable mirror 184 combination may be used by each probe apparatus 106, 107 to measure the remaining thickness of a wall section that has been subject to touch point corrosion.

Referring to FIG. 4, a schematic illustration shows first probe apparatus 106 and second probe apparatus 107 positioned adjacent to the pipe 10 in a scanning position according to embodiments of the present disclosure. Probe apparatuses 106, 107 are disposed on opposite sides of the pipe 10 at a bottom section of the pipe 10 and are separated by probe separation distance 11. A wall section 23 which may overlie a pipe support (not shown) may be scanned by probe apparatuses 106, 107 to determine remaining wall thickness. A transverse width 13 of the test wall section 23 may be scanned between the probe apparatuses 106, 107 and at the corrosion loss area 22. Wall thickness may be determined by projecting ultrasound waves from probes 182 of the probe apparatuses 106, 107 to the internal diameter surface 12 and outer diameter surface 14 of the pipe 10 at the test wall section 23. The ultrasound waves projected to the internal diameter surface 12 may be referred to as an ID surface signal 16 and the ultrasound waves projected to the outer diameter surface 14 may be referred to as an OD surface signal 18. The OD surface signal 18 is shown projected from the first probe apparatus 106 and an OD surface signal (not shown) from the second probe apparatus 107 is also projected. The thickness of the test wall section may be determined by measuring the time difference between reflected waves from the ID surface signal 16 and the OD surface signal 18 received by the probe apparatuses 106, 107. The time difference Δt of the ID reflection time t of the ID surface signal 16 and the OD reflection time t′ of the OD surface signal 18 is shown by equation 1 below:

t′−t=Δt (equation 1)

Touch point corrosion may cause the test wall section 23 to have a wall thickness that has decreased such that a remaining wall thickness is less than the specified wall thickness for the pipe 10. The portion of the test wall section 23 that has been lost due to touch point corrosion is illustrated by an OD line 20 representing the specified or actual OD of the original pipe 10 in the test wall section 23 before corrosion reduced the wall thickness to a resulting outer pipe surface 24. A corrosion loss area 22 is schematically illustrated and located between the OD line 20 and the resulting outer diameter surface 24 at the test wall section 23.

In operation, UT inspection scanner 100 may be used to scan the pipe 10. Frame assembly 102 is placed in an open position where second frame section 110 is pivoted at the frame hinge 112 to provide a pipe access opening sized to receive the pipe 10 into the internal diameter area 124. Frame assembly 102 is then positioned on the pipe 10 and second frame section 110 is moved to the closed position where the frame sections 108, 110 are closed together. In the closed position, frame section ends 114 are adjacent to each other and the access ends 116 are adjacent to each other so that the frame assembly 102 fits around the circumference of the pipe 10 in the mounted position. Frame assembly 102 may be supported on the pipe 10 by, for example, the wheel assembly 126 and the frame connectors 146, 166. Wheel 132 engages a top surface of the pipe 10 and is configured to allow the frame assembly 102 to be longitudinally moved with respect to the pipe 10 while the frame assembly 102 is closed.

With the frame assembly 102 mounted on the pipe 10, the UT inspection scanner 100 is rolled into a test position on the pipe 10 where the probe apparatuses 106, 107 are positioned on opposite sides of a test wall section 23 of the pipe 10. Probe carriers 140, 142 extend from the frame assembly 102 to position the probe apparatuses 106, 107 a probe extended distance from the frame assembly 102. By spacing the probes 182/probe apparatuses 106, 107 a desired distance from frame assembly 102, the probes 182 are more easily positioned adjacent to a pipe support or other obstruction which could otherwise block attachment of the frame assembly 102. This facilitates positioning of the probe apparatuses 106, 107 adjacent to a desired test wall section 23 located above, for example, a pipe support while the frame assembly 102 is attached to the pipe 10 at a separate, distant location.

Probes 182 of probe apparatuses 106, 107 are used to project ultrasound waves to the test wall section 23 and to receive the reflected ultrasound waves. Signals corresponding to the reflected ultrasound waves are communicated using communication lines and power lines extending through the housing channels 174, 176 to a controller (not shown), having a processor and memory. The controller processes the reflected ultrasound waves to determine the pipe thickness at the test wall section.

UT inspection scanner 100 may be moved from one test wall section to another test wall section at longitudinally spaced apart locations by rolling the frame assembly 102 being supported on the pipe with the wheel assembly 126. Frame assembly 102 may sometimes stay in the mounted position on the pipe 10 with the frame assembly 102 in the closed position when the UT inspection scanner 100 is moved longitudinally from one test wall section to another test wall section. UT inspection scanner 100 is moved by rolling frame assembly 102 on the pipe 10 using the wheel assembly 126.

The UT inspection scanner 100 provides for effective positioning of probe apparatuses and adjustments of the probe apparatuses at a desired test wall section 23. The probe apparatuses may be efficiently moved from one test wall section to another test wall section. It should be noted the UT inspection scanner 100 may be constructed in various sizes and configurations. For example, the frame assembly 102 may be constructed with a variety of internal and external diameters and the hinged components may constructed with various materials in a variety of sizes and shapes. Similarly, the probe carriers 140, 142 may have various lengths and configurations to position each probe apparatus 106, 107 at a desired location with respect to frame assembly 102. Additionally, various types of probes 182 and corresponding mirrors and other equipment may be utilized, as known to those of ordinary skill in the art.

Although a few embodiments of the disclosure have been described in detail above, those of ordinary skill in the art will readily appreciate that many modifications are possible without materially departing from the teachings of this disclosure. For example, the pipe isolation device of the present disclosure may be modified by adding additional sealing heads to become a triple, or more, block and bleed apparatus. Accordingly, such modifications are intended to be included within the scope of this disclosure as defined in the claims. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. An ultrasonic testing (UT) inspection scanner for scanning a pipe, comprising:
a frame assembly having a first frame section and a second frame section hinged together, wherein the frame assembly is configured to be positioned between an open position to allow the frame assembly to be placed on the pipe and a closed position where the frame assembly is mounted on the pipe with the frame assembly extending around a circumference of the pipe;
a first probe carrier having an elongated shape with a first attachment end and a first extended end;
a second probe carrier having an elongated shape with a second attachment end and second extended end;
a first probe apparatus coupled to the first probe carrier, and wherein the first probe apparatus is attached at the first extended end of the first probe carrier;
a second probe apparatus coupled to the second probe carrier, and wherein the second probe apparatus is attached at the second extended end; and
a wheel attached to the frame assembly and configured to allow the frame assembly to move longitudinally on the pipe when the frame assembly is in the closed position.

2. The UT inspection scanner as recited in claim 1, wherein the first probe carrier and the second probe carrier are attached to a bottom section of the frame assembly and extend longitudinally from the frame assembly.

3. The UT inspection scanner as recited in claim 1, wherein the frame assembly has a cylindrical shape with an interior diameter.

4. The UT inspection scanner as recited in claim 3, wherein the interior diameter is larger than the diameter of the pipe to create an annular region between the pipe and an interior surface of the frame assembly.

5. The UT inspection scanner as recited in claim 1, wherein the first probe carrier comprises an extended housing having an elongated wedge shape.

6. The UT inspection scanner as recited in claim 1, wherein the first probe carrier comprises an extended housing having an outer surface with a concave shape.

7. The UT inspection scanner as recited in claim 1, wherein the second probe carrier comprises an extended housing having an elongated wedge shape.

8. The UT inspection scanner as recited in claim 1, wherein the second probe carrier comprises an extended housing having an outer surface with a concave shape.

9. The UT inspection scanner as recited in claim 1, wherein each of the first and second probe carriers comprises an extended housing having a frame connection sized to fit into a frame slot of the frame assembly.

10. The UT inspection scanner as recited in claim 1, wherein each of the first probe apparatus and the second probe apparatus comprises a probe for projecting and receiving ultrasound waves during scanning of the pipe.

11. A system, comprising:
a UT inspection scanner comprising probes for projecting and receiving ultrasound waves to determine corrosion in a wall section of a pipe, the UT inspection scanner comprising:
a frame assembly to which a pair of elongated probe carriers are attached via frame connectors, the pair of elongated probe carriers further comprising probe supports for holding the probes at a desired distance from the frame connectors and thus from the frame assembly, the frame assembly being actuatable between an open position to receive the pipe and a closed position to secure the frame assembly to the pipe at the desired distance from the probes when the probes are positioned at the corrosion in the wall section.

12. The system as recited in claim 11, wherein the frame assembly comprises frame sections coupled together via a hinge.

13. The system as recited in claim 12, wherein the frame assembly is cylindrical in shape with an interior diameter sized to receive the pipe therein.

14. The system as recited in claim 13, wherein the desired distance is greater than the interior diameter.

15. The system as recited in claim 11, wherein each probe carrier of the pair of probe carriers comprises an extended housing having an elongated wedge shape.

16. The system as recited in claim 11, wherein each probe carrier of the pair of probe carriers comprises an extended housing having an outer surface with a concave shape.

17. A method of testing for corrosion on a pipe, comprising:
providing a UT inspection scanner with a frame assembly and a pair of probe carriers extending from the frame assembly;
positioning ultrasound probes in probe supports of the probe carriers so the ultrasound probes are spaced a desired distance from the frame assembly;
opening the frame assembly via a hinge;
positioning the frame assembly about the pipe; and
closing the frame assembly to mount the UT inspection scanner to the pipe via the frame assembly, the frame assembly being used to secure the UT inspection scanner to the pipe at the desired distance from corrosion on the pipe while the probes are held proximate the corrosion.

18. The method as recited in claim 17, further comprising moving the UT inspection scanner along the pipe to adjust its position.

19. The method as recited in claim 18, further comprising using a wheel mounted to the frame assembly to facilitate movement of the UT inspection scanner along the pipe.

20. The method as recited in claim 19, further comprising reopening the frame assembly via the hinge to release the UT inspection scanner from the pipe.
